(19) United States
(12) Patent Application Publication
(10) Pub. No.: US 2008/0255997 A1
(43) Pub. Date: Oct. 16, 2008

(54) ENTERPRISE INTEGRATED BUSINESS PROCESS SCHEMA

(76) Inventors: Thomas H. Bluhm, Auburn, WA (US); Gregory A. Lynch, Seattle, WA (US); Yung S. Kim, Bellevue, WA (US)

Correspondence Address: KLEIN, O'NEILL & SINGH, LLP, 43 CORPORATE PARK, SUITE 204, IRVINE, CA, 92606, US

(21) Appl. No.: 11/735,874

(22) Filed: Apr. 16, 2007

(51) Int. Cl. G06F 17/00; H04K 1/00; H04L 9/00

(52) U.S. Cl. 705/80

(57) ABSTRACT

A computer implemented method, apparatus, and computer usable program code for exchanging process model data between process authoring tools in a process management system. A set of information requirements for exchanging the process model data between process authoring tools using different process model exchange formats within the process management system is identified. A definition of a common process model exchange format is extended to include a set of common objects using the set of information requirements to form a common process model exchange format. The set of common objects are supported between a source process authoring tool and a target process authoring tool in the process authoring tools. An output file is generated using the common process model exchange format. The common process model exchange format is compatible with a process model exchange format used by the target process authoring tool.

### BACKGROUND INFORMATION

1. Field of Invention

The present invention relates generally to a data processing system and in particular to a method and apparatus for data exchange. More particularly, the present embodiments are directed to a computer implemented method, apparatus, and computer usable program code for protecting and exchanging business process models between environments using differing process model authoring systems.

2. Background Description

An enterprise typically refers to a business or an organization. An enterprise is frequently composed of multiple business sites, departments, computer systems, networks, and other resources that are used for the purpose of creating, analyzing, producing, testing, and/or delivering products to customers. Enterprises generally employ a multitude of different processes to govern the activities required to effectively and efficiently utilize resources to generate and deliver products and services to customers.

A process is a set of interrelated or linked activities that generate values by transforming inputs into desirable or more valuable outputs. A process definition is a specification of the value stream of a business process. In other words, a process definition depicts the beginning and ending of an activity flow.

A process model is a structure of business methods, information, resources, and constraints. A process may be thought of as an instantiation of a process model. In other words, a process model is a diagram or framework for visualizing the structure and interconnections of different types of processes. A process model is used to provide a visualization of the elements of multiple interrelated business activities, such as the beginning of a process, ending of a process, inputs received by a process, outputs generated by a process, and/or events associated with objectives and goals of businesses. A process model also provides a means of sharing ideas and specific approaches between business entities.

Business process models are used to generate, document, understand, re-create, and/or improve business strength for competitiveness or positioning in a market. These business process models may be used to manage, define, visualize, control and mature processes occurring within an enterprise for optimum effectiveness, efficiency, emotions, and profitability.

Business process execution language (BPEL) is an industry standard for sharing process models. In other words, business process execution language is a process model exchange language that is intended for communicating data and metadata associated with process models between dissimilar computing systems. Business process execution language may be used for specifying and building sharable business process models, defining the behavior of business processes at an abstract level, and creating process definitions for executable instances of a process.

However, currently available process model exchange languages, such as business process execution language, do not contain provisions for protecting sensitive data from disclosure during data exchange. Moreover, these process model exchange languages do not provide methods for tailoring data to meet customers and/or vendors' unique data requirements. In other words, if a customer or vendor is using a customized or modified version of the standard process model exchange language, the customer or vendor may not be able to exchange data with a business entity using a unmodified version of the standard process model exchange language, a version of the standard process model exchange language modified in a different manner, and/or an entirely different process model exchange language.

Current solutions require entities to use a common version of a process model exchange language to exchange process data between those entities. However, business entities frequently utilize multiple differing process model exchange languages associated with a variety of process authoring tools. In addition, entities within a business or enterprise typically exchange data with many different partners, suppliers, customers, and other entities outside the enterprise. Thus, it is infeasible for an enterprise to ensure that every entity within the enterprise and every entity outside the enterprise implement or integrate the same process models seamlessly.

Another problem is manual process deployment. This requires a human user to manually re-create process models to conform to a business practice associated with another entity. The human user must also manually correct any errors that occur during the manual re-generation of process models. This manual method is tedious, cumbersome, inconvenient, and may be cost prohibitive. This solution may be particularly painful in a global market.

### SUMMARY OF THE INVENTION

The illustrative embodiments provide a computer implemented method, apparatus, and computer usable system for creating an aerospace apparatus. A set of information requirements for exchanging the process model data between process authoring tools using different process model exchange formats within the process management system is identified. The process authoring tools are tools for creating the process for defining aerospace apparatus. A definition of a common process model exchange format is extended to include a set of common objects using the set of information requirements to form a common process model exchange format. The set of common objects are supported between a source process authoring tool and a target process authoring tool in the process authoring tools. The set of common objects may include, but is not limited to, a keyword, a relationship, an object, an activity, a role, a class, a business class, a location, a deliverable, and/or an organization. An output file is generated using the common process model exchange format. The common process model exchange format is compatible with a process model exchange format used by the target process authoring tool.

In another illustrative embodiment a computer implemented method for exchanging process model data between process authoring tools in a process management system is provided. In this embodiment, a set of information requirements for exchanging the process model data between process authoring tools using different process model exchange formats within the process management system is identified. A definition of a common process model exchange format is extended to include a set of common objects using the set of information requirements to form a common process model exchange format. The set of common objects are supported between a source process authoring tool and a target process authoring tool in the process authoring tools. An output file is generated using the common process model exchange format. The common process model exchange format is compatible with a process model exchange format used by the target process authoring tool.

The illustrative embodiments also provide a process modeling system. The process modeling system includes a translation application that identifies a set of information requirements for exchanging the process model data between process authoring tools using different process model exchange formats within the process management system. The process authoring tools are tools for creating the process for defining aerospace apparatus. The system also includes a process model database that stores a set of common objects that are supported between a source process authoring tool and a target process authoring tool in the process authoring tools. The system includes a mapper for extending a definition of a common process model exchange format to include the set of common objects using the set of information requirements to form a common process model exchange format and generates an output file using the common process model exchange format. The common process model exchange format is compatible with a process model exchange format used by the target process authoring tool.

In another illustrative embodiment, a computer program product having computer usable program code encompasses the steps for exchanging process model data between process authoring tools in a process management system. In this embodiment, the computer program product is executed to perform the steps in the present methods.

The features, functions, and advantages can be achieved independently in various embodiments of the present enterprise integrated business process schema or may be combined in yet other embodiments.

### BRIEF DESCRIPTION OF THE DRAWINGS

The novel features believed characteristic of the present embodiments are set forth in the appended claims. The present embodiments, however, as well as preferred modes of use, further objectives and advantages thereof, will best be understood by reference to the following detailed description of advantageous embodiments when read in conjunction with the accompanying drawings, wherein:

FIG. 1 is a pictorial representation of a network of data processing systems in which an advantageous embodiment of the present enterprise integrated business process schema may be implemented;

FIG. 2 is a diagram of a data processing system in accordance with an advantageous embodiment of the present enterprise integrated business process schema;

FIG. 3 is a block diagram illustrating a dataflow when process models are exchanged between multiple entities using disparate authoring tools in accordance with an advantageous embodiment;

FIG. 4 is a block diagram illustrating a dataflow when data associated with process models are exchanged between entities using a rule-based extendable process exchange controller in accordance with an advantageous embodiment;

FIG. 5 is a block diagram illustrating a class diagram view of a rule-based process model exchange controller in accordance with an advantageous embodiment;

FIG. 6 is a flowchart illustrating a process for converting an export file in a first process model exchange format to a tool-neutral modeling format by a mapping component in accordance with an advantageous embodiment;

FIG. 7 is a flowchart illustrating a process for processing an export file associated with a first process model exchange format for exchange with an entity utilizing a second process model exchange format using a relational database in accordance with an advantageous embodiment;

FIG. 8 is a flowchart illustrating a process for an application to export a file in a first process model exchange format to a destination associated with a second process model exchange format in accordance with an advantageous embodiment; and

FIG. 9 is a flowchart illustrating a process for constructing a file compliant with a common exchange format in accordance with an advantageous embodiment.

### DETAILED DESCRIPTION OF THE PREFERRED EMBODIMENTS

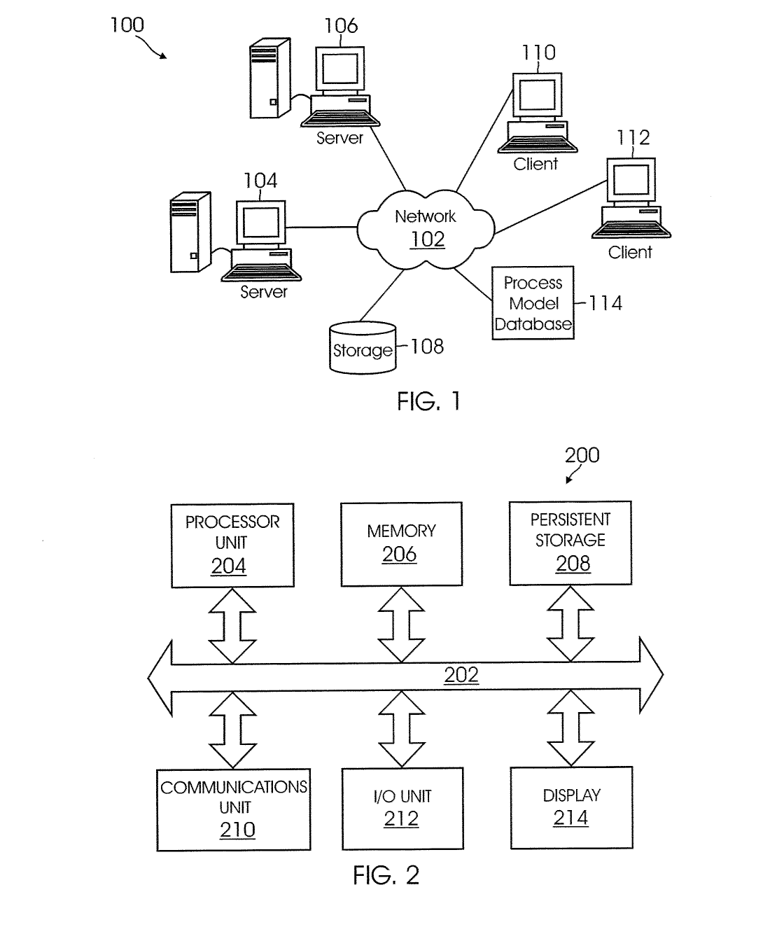

With reference now to the figures and in particular with reference to FIGS. 1-2, high level architecture diagrams of process exchange environments are provided in which illustrative embodiments may be implemented. It should be appreciated that FIGS. 1-2 are only examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network computing system 100 is a network of computers in which the illustrative embodiments may be implemented. For example, network data processing system 100 may be used for processing process models, such as, but not limited to, business process models.

Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110 and 112 connect to network 102. Clients 110 and 112 may be, for example, personal computers or network computers. In the depicted example, server 104 provides data, such as boot files, operating system images, and applications to clients 110 and 112. Clients 110 and 112 are clients to server 104 in this example.

Process model database 114 is also connected to network 102. Process model database 114 is any type of known or available data storage device for storing process models, such as, but not limited to, a relational database. In this example, process model database 114 is a relational database that conforms to the relational model. In this example, process model database 114 is a single database for storing process models. However, network computing system 100 may include multiple process model databases for storing process models.

Process models may be used to provide definitions or descriptions of one or more processes based on the type of the process. Processes of the same type are frequently classified or described together within a process model. Thus, a process may be an instantiation of a given process model. A process may be performed by a human, a computer system, an application, or a combination of a human, a computer system, and/or an application. An application is computer software that uses the resources of a computing device to perform a task or provide a service.

Process model database 114 includes one or more databases for performing functions such as storing, receiving, sorting, querying, organizing, and/or manipulating data associated with processes and/or process models. Data in process model database 114 is stored in one or more tables in process model database 114. The process model data may also be stored in a modular form in process model database 114. Thus, individual modules associated with a part or portion of a process model may be used to generate data or metadata associated with a process or process model rather than using an entire process model. In this manner, a given instance of a process may be generated based on modular portions of multiple disparate process models.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as, for example, an intranet, an Ethernet, the Internet, a wireless network, a local area network (LAN), or a wide area network (WAN).

FIG. 1 is intended as an example, and not as an architectural limitation for the different illustrative embodiments. Network data processing system 100 may include additional servers, clients, data storage devices, databases, and other devices not shown in FIG. 1.

Turning now to FIG. 2, a diagram of a data processing system is depicted in accordance with an advantageous embodiment of the present enterprise integrated business process schema. In this illustrative example, data processing system 200 may be used for processing process models, such as, without limitation, business process models.

Data processing system 200 includes, but is not limited to, communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 206 may be implemented using one or more heterogeneous processor systems in which a main processor is present with secondary processors on a single chip. Memory 206, in these examples, may be, for example, a random access memory. Persistent storage 208 may take various forms, depending on the particular implementation. For example, persistent storage 208 may be, for example, a hard drive, a flash memory, a rewritable optical disk, a rewritable magnetic tape, or some combination of the above.

Communications unit 210, in these examples, provides for communications with other data processing systems or devices. In these examples, communications unit 210 is a network interface card. I/O unit 212 allows for input and output of data with other devices that may be connected to data processing system 200. For example, I/O unit 212 may provide a connection for user input through a keyboard and mouse. Further, I/O unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206.

The illustrative embodiments recognize that business process execution language and other currently available process model exchange languages do not contain the needed fidelity or functionality to restrict and/or extend process model data for the protection of proprietary data. Therefore, the illustrative embodiments provide a common method for protecting data during data exchange that is independent of the process model toolset used. In other words, the illustrative embodiments provide for exchange process models between different entities that is independent of the type of process model authoring software and/or process model exchange format associated with the different entities.

The illustrative embodiments provide a computer implemented method, apparatus, and computer program product for exchanging process model data between process authoring tools in a process management system. In this embodiment, a set of information requirements for exchanging the process model data between process authoring tools using different process model exchange formats within the process management system is identified. A definition of a common process model exchange format is extended to include a set of common objects using the set of information requirements to form a common process model exchange format. The set of common objects is a set of one or more objects, relationships, classes, and/or keywords that are supported between a source process authoring tool and a target process authoring tool in the process authoring tools. A source process authoring tool is an authoring tool associated with an entity generating an output file that is to be sent to a recipient. A target process authoring tool is an authoring tool that is associated with an entity that is an intended recipient of the output file generated by the entity generating the output file.

An output file is generated using the common process model exchange format. The common process model exchange format is compatible with a process model exchange format used by the target process authoring tool. In other words, a source output file is generated by the source entity using a source authoring tool for transmission to a target entity using a target authoring tool that is different than the source authoring tool. Thus, the source output file may be in a format that is not compatible with the authoring tools associated with the target entity. Therefore, a second output file is generated using a set of common objects. In this example, the second output file is compatible with one or more authoring tools used by or available to the target entity.

The illustrative embodiments may also be used to exchange process model data between process authoring tools for creating aerospace apparatus. In this example, the process authoring tools are authoring tools associated with designing, testing, and/or manufacturing aerospace apparatus. An aerospace apparatus may include aircraft apparatus, or spacecraft apparatus. Aerospace apparatus may include, but is not limited to, any part, piece, component, assembly, machine, or equipment associated with an aircraft. For example, an aircraft apparatus can include, but is not limited to, an airframe, an engine, a passenger seat, a fuselage, a tail section, a frame, a radio, or any other part or assembly associated with aircraft.

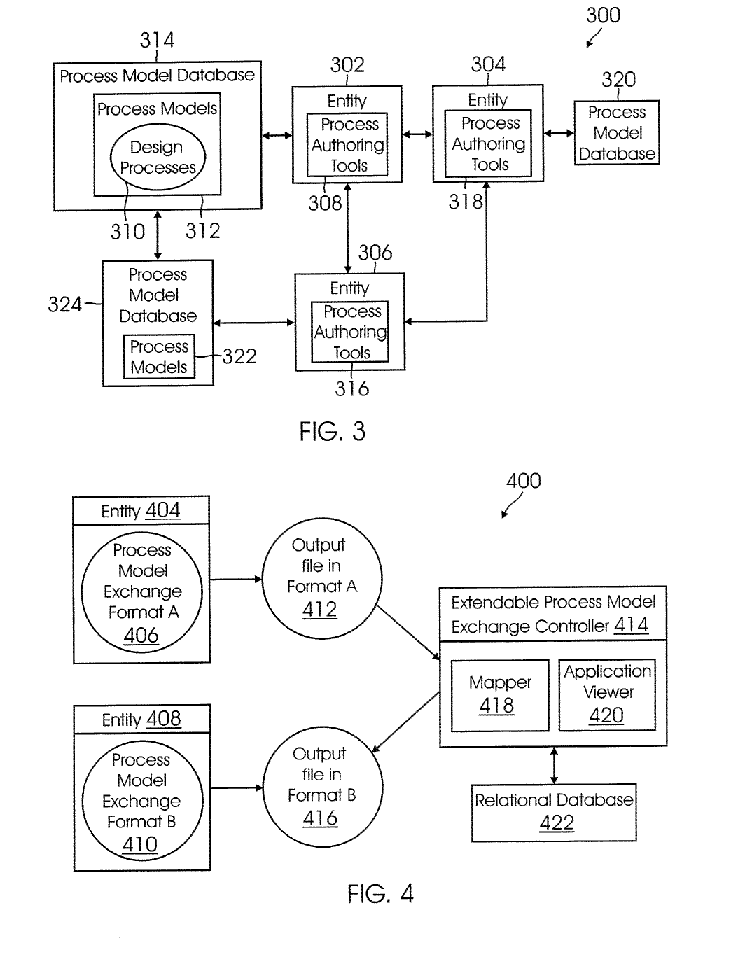

FIG. 3 is a block diagram illustrating a dataflow when process models are exchanged between multiple entities using disparate authoring tools in accordance with an advantageous embodiment. Network data processing system 300 is a data processing system, such as, without limitation, network data processing system 100 in FIG. 1. Network data processing system 300 includes multiple disparate entities, including, but not limited to, entity 302, entity 304, and entity 306.

Entities 302-306 may be any type of entities. In this example, an entity may be a human user, a group of human users, one or more hardware components, software components, such as an application, and/or any combination of human users, hardware, and/or software. For example, an entity may include, but is not limited to, a human user at a computing device, such as client 110 or server 104 in FIG. 1, a software application, and/or an entity associated with a web service.

In this example, entity 302 is a design group located at a design facility for designing aerospace apparatus. Entity 302 includes human users, a computer system, and/or application software for designing machines and other manufactured items. For example, entity 302 may be, without limitation, a design group that designs airframes, including wings, fuselage, and flaps for aircraft.

Entity 302 includes process authoring tools 308. Process authoring tools 308 includes one or more applications or software tools for generating, manipulating, modifying, and utilizing design processes 310 and/or process models 312. A process is a value generation method that links a set of activities to transform inputs, such as material or information, into intended outputs that represent something of value, such as business or product values, to an enterprise. In this example, design processes 310 are processes used during the design of aerospace products, such as, but not limited to, processes used during the design of aircraft. However, in accordance with the illustrative embodiments, processes are not limited to design processes.

Design processes 310 are represented by process models 312. A process model is a system of structured business operational elements, such as activities, information, constraints, resources, roles, materials, and relationships associated with one or more processes. Process models 312 are generally built at multiple levels as the scope of one or more processes represented by a given process model expands. The objective of having a process model is to capture the information in a stable form that may later be used to communicate the content of a process.

The representation of a process in a process model may take several forms, including, but not limited to, a graphical model, a textual model, and a parametric model. Process models may be realized or output in various media and forms, including: diagrams on a computer screen, an illustration in a document; as text in a text file; data within a database; and/or as structured data stored in computer memory. For example, a graphical representation of a process can depict process model information with lines, boxes, text boxes, and other icons. Typically graphical representation will portray activities, business items, organizational roles, and their relationships.

Process model information, as structured data, may be found in a computer memory, a text file, or a database, such as process model database 314. Process model database 314 is a repository for storing process models, such as process model database 114 in FIG. 1. The information content of a process model stored in process model database 314 may include cost, time to execute, business rules, supporting mechanisms, or constraints associated with one or more processes. In the example of a graphical representation of a process, the process model information includes, but is not limited to, definitions of the graphical elements.

In global operations or a teamwork environment, a process model may also provide important benefits. For example, process models 312 may be used to facilitate communication among partners and team members as to how the business will be performed by answering questions, such as who, what, where, when, why, and how business processes will be performed. Process models 312 may also provide agility for the entire organization to quickly adjust to the dynamic business environment. In other words, process models 312 may assist differing entities in adaptations to changing business environments and needs. In this example, process models 312 are used to facilitate communications between entity 302, entity 304, and entity 306.

An enterprise that uses multiple different process models, process repositories, process communication, and exchanges processes may require collaboration of multiple vendor authoring tools. Process authoring tools are applications and other software for creating, manipulating, and modifying processes and/or process models. Process authoring tools 308, 316, and 318 may include, without limitation, text editor tools for creating and editing text documents, drawing tools, such as VISIO®, and/or business modeling tools, such as WEBSPHERE® business modeler.

In this example, entity 302 utilizes process authoring tools 308, entity 306 uses process authoring tools 316, and entity 304 uses process authoring tools 318. Process authoring tools 308, 316, and 318 may be different types of authoring tools, different versions of the same authoring tools, and/or modified or customized versions of the same authoring tools.

Thus, in this illustrative example, entity 302, a design group, generates process models 312. Process models 312 may include, without limitation, airframe definition process models for aircraft airframes that include components, such as wings, fuselage, and flaps. The airframe definition process models include a system of structured process operational elements for design processes associated with designing airframes for aircraft.

When entity 302 completes the airframe definition, process models 312 are sent to entity 304 to enable entity 304 to understand airframe design requirements and objects. In this example, entity 304 is a wind tunnel test facility that uses one or more testing processes to test aircraft designs. Entity 304 may be located locally to entity 302, such as in the same room, building, or complex. Likewise, entity 304 may be located remotely to entity 302, such as a location in another town or state. Entity 304 stores data associated with processes and/or process models in process model database 320. Process model database 320 is a repository database for storing process models, such as process model database 114 in FIG. 1. For example, process model database 320 could store, without limitation, data associated with design processes 310 and process models 312 received from entity 302, as well as data associated with test processes and/or test process models used by entity 304.

Engineers in the wind tunnel test facility associated with entity 304 import process models 312, including the airframe definition process models, to a computer system of entity 304 that is dissimilar to a computer system associated with entity 302. Entity 304 needs data associated with process models 312 to understand what to test and how to test to produce proper air load data for the airframe. The imported process models 312 will show how the airframe is designed, what is required from the wind tunnel test, which entities would need deliverables from the tests, and any other data related to testing the airframe. A deliverable refers to a discrete component of a project.

In this illustrative example, entity 306 may be, without limitation, a manufacturing group utilizing one or more manufacturing processes to manufacture airframes and other aircraft parts and components. Entity 306 stores data associated with processes and process models 322 in process model database 324. Process model database 324 is a relational database for storing process models, such as process model database 114 in FIG. 1.

In this example, process models 322 are models for manufacturing and engineering processes. Manufacturing processes and manufacturing process models are frequently stored as digital documents in a variety of databases, such as, without limitation, process model database 324. The manufacturing and engineering processes are frequently authored or generated in a variety of forms, including but not limited to, text documents, VISIO® diagrams, and WEBSPHERE® business modeler.

Thus, in this example, entities 302-306 use different process authoring tools 308, 316, and 318, and different process modeling methodologies. Some data associated with the various processes for designing, testing, and manufacturing may be document based with embedded figures, diagram based with little additional textual information, data in a system that supports simulation so that cost and duration are modeled, and some process models may be created using multiple tools with components of the process model distributed amongst the various tools. In addition, some work in process models may be performed using integrated tools, such as PROVISION® by Proforma Corporation of Southfield, Mich. However, entities 302-306 may need to exchange data associated with processes and process models associated with different process authoring tools and/or process model exchange languages. Therefore, the illustrative embodiments provide an extendable process model exchange controller for pulling data associated with processes and process models from multiple different process authoring tools and multiple different process methodologies into a more standardized representation that can be exchanged between multiple entities, such as entities 302-306.

FIG. 4 is a block diagram illustrating a dataflow when data associated with process models are exchanged between entities using a rule-based extendable process exchange controller in accordance with an advantageous embodiment. Process management system 400 is a data processing system, such as network data processing system 100 in FIG. 1. In this example, process management system 400 includes two or more entities attempting to exchange data associated with process models using multiple dissimilar exchange formats.

Entity 404 is an entity associated with process model exchange format A 406. Entity 404 may be any type of entity, including, but not limited to, a hardware component, a software component, or a combination of hardware and software. In this example, entity 404 is implemented as a software application on a computing device, such as client 104 or server 106 in FIG. 1. An application may include a software application, a web service, or any other program for performing a task using the resources of a computing device.

Process model exchange format A 406 is a data exchange standard used for formatting process data for transmission to another entity, such as entity 408. Process model exchange format A 406 may provide a schema and/or a list of key words for formatting data for exchange between two entities. In this example, process model exchange format A 406 is an instance of business process execution language (BPEL). Entity 404 generates output file in format A 412. Entity 404 sends output file in format A 412 to entity 408.

Entity 408 is an entity, such as entity 404. Entity 408 is associated with process model exchange format B 410. Process model exchange format B 410 is a format used for exchanging process model data with another entity. Process model exchange format B 410 is a different process model exchange format than process model exchange format A 406. For example, process model exchange format B 410 may be a modified or customized version of process model exchange format A 406. Process model exchange format B 410 may also be a completely different process model exchange format from process model exchange format A 406. Likewise, process model exchange format A 406 may be the modified or customized version of process model exchange format B 410.

In other words, process model exchange format A 406 and process model exchange format B 410 are differing process model exchange formats or differing versions of a process model exchange format. In this example, process model exchange format B 410 is a customized or modified version of business process execution language which may be referred to as “B2PEL”. Therefore, output file in format A 412 sent by entity 404 must be converted into a format that will be compatible with process model exchange format B 410 of entity 408.

Extendable process model exchange controller 414 is a software component utilizing an extendable, tool-neutral modeling format to convert output file in format A 412 into a tool-neutral modeling format that will be compatible with process model exchange format B 410. Extendable process model exchange controller 414 performs a process consisting of taking an output file in a first process model exchange format associated with any known or available industry process authoring application and extending and/or restricting the definitions of the process model format to maximize or enable data exchange with a process modeling application utilizing a different process model exchange format than the output file.

In this example, extendable process model exchange controller 414 includes, but is not limited to, mapper 418 and application viewer 420. Mapper 418 is a software component with capabilities of creating schema, system schema, rules for mapping, data tagging, extending & restricting, and storing and retrieving for converting an export file in a first process model exchange format to a tool-neutral modeling format.

Mapper 418 parses an output file in process model exchange format A 406 and builds a translation standard between process model exchange format A 406 and process model exchange format B 410. The translation standard is a unified schema incorporating common objects between the differing exchange formats and adding needed objects to make the unified exchange format compatible.

In other words, mapper 418 parses an output file into its component parts, such as classes, objects, and relationships. The classes, objects, and/or relationships may be represented by key words. Mapper 418 excludes key words that are not supportive of a destination process model exchange format. A destination process model exchange format is a process model exchange format associated with an entity that is a target or intended recipient of the output file, such as entity 408. In this example, the destination process model exchange format is process model exchange format B 410.

In one embodiment mapper 418 tags modular data to be restricted or excluded from the intermediate or unified process model exchange format. The modular data tagged for exclusion may include, but is not limited to, relationships, classes, and/or objects that are not supportive of process model exchange format B 410. In other words, mapper 418 tags data to eliminate kev words that are not needed in the unified schema. As used herein, a unified schema refers to a set of business rules, objects, classes, and relationships that may be needed for generating an exchange file compliant with a process model exchange format of a destination entity, such as process model exchange format B 410.

Mapper 418 also tags modular data to be added to the unified schema to increase the level of process definition. In other words, relationships, objects, and/or classes that are needed to be compatible with process model exchange format B 410 are tagged for addition to the unified schema.

Mapper 418 loads the common objects identified for inclusion in the unified schema into data storage, such as relational database 422. Common objects are objects that are supportive of process model exchange format B 410. Objects that are excluded by mapper 418 are not stored in relational database 422 as common objects.

Relational database 422 is a database based on the relational model. Relational database 422 may be any type of relational database. In this example, relational database 422 is a repository for storing data associated with processes and/or process models, such as process model database 114 in FIG. 1 or process model database 314 in FIG. 3. Relational database 422 provides a repository for storing tagged data, such as common objects.

Mapper 418 retrieves the common objects associated with process model exchange format B 410 from relational database 422. The common objects are modular data. In other words, common objects may be used in association with one or more differing process models and/or process model exchange formats. Mapper 418 uses the retrieved common objects to generate an output file that is compliant with process model exchange format B 410.

Mapper 418 generates the compliant output file by making a query to relational database 422. In response to the query, relational database 422 returns the state of the objects stored in relational database 422. In this example, objects common to two or more process model exchange formats may be indicated by a flag associated with the object. The object state determines the procedures and rules for storing the common process objects in relational database 422.

Mapper 418 constructs output file in format B 416, using the object states and a set of business rules. The set of business rules are predefined rules to guide the construction of the common exchange format file. The set of business rules are provided by a user and/or other entity.

Application viewer 420 is a software component for displaying graphical representations of process models. Application viewer 420 may be any type of known or available software for displaying graphical representations of process models. Output file in format B 416 generated by mapper 418 may be viewed on application viewer 420. Extendable process model exchange controller 414 then sends output file in format B 416 to entity 408. Because output file in format B 416 is compliant with the process model exchange format used by entity 408, entity 408 is able to receive and process output file in format B 416 from entity 404 without performing any manual conversion of the file format and without having the same process model exchange format as entity 404.

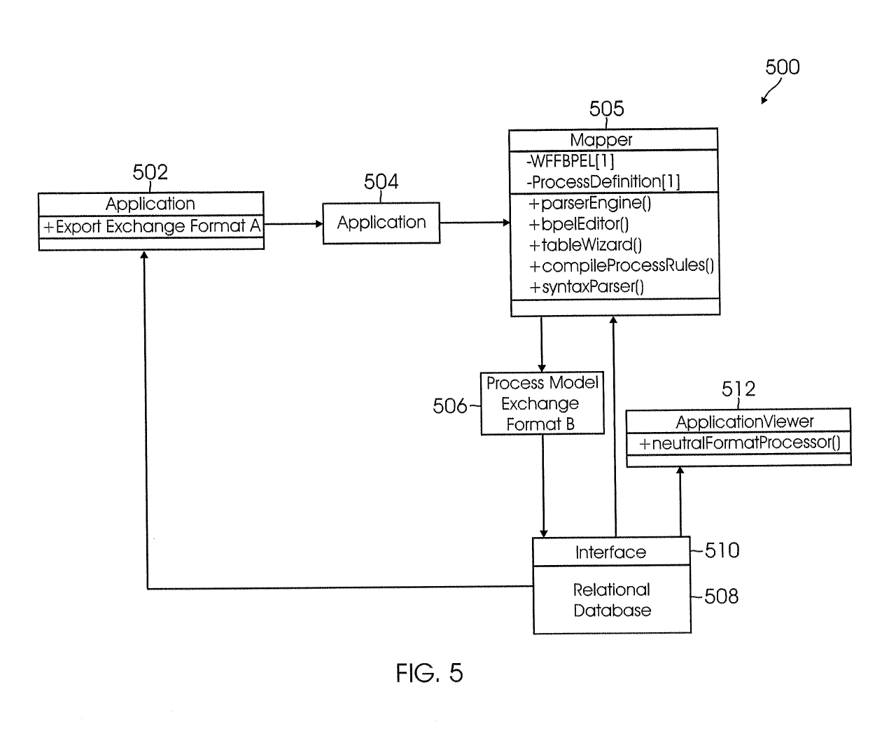

FIG. 5 is a block diagram illustrating a class diagram view of a rule-based process model exchange controller in accordance with an advantageous embodiment. Class diagram 500 is a view of a class diagram for an extendable data exchange controller, such as extendable process model exchange controller 414 in FIG. 4. Class diagram 500 includes the functional components of an extendable data exchange controller, as well as the class objects for variables and methods associated with each functional component.

Application 502 is an entity, such as entity 302 in FIG. 3 or entity 404 in FIG. 4. In this example, application 502 is a software application for performing a process modeling activity, such as a process authoring software tool.

Application 504 is a data process model in exchange format A. In this example, application 504 is an authoring tool in a standard process model exchange format, such as process model exchange format A 406 in FIG. 4. For example, process model exchange format A may be a business process execution language (BPEL) process model exchange format.

Application 504 identifies the information requirements of process model exchange format A for exchanging data between entities in the process management system. In other words, application 504 may be a translation application that defines business processes that involve business process definitions. Defining business processes may include identifying the names of activities, work items, business rules, and other information associated with the business process definition.

Application 504 uses process model exchange format A to generate an output file to be sent to a target process authoring system. A target process authoring system is a process authoring system utilized by a recipient or destination computing system.

The output file may include any type of data to be exported to a target application, including but not limited to, a report or exchange file. A target application is an application associated with the recipient or destination of the output file. The output file is formatted in process model exchange format A of application 504. In this example, the output file is formatted in business process execution language.

Extendable process model exchange controller shown in class diagram 500 includes mapper 505. Mapper 505 is a software component for building a rule-based translation between an entity using a first model exchange format and an entity using a second model exchange format. In this example, mapper 505 is a mapping component, such as mapper 418 in FIG. 4.

The class definition for mapper 505 may include, but is not limited to, function calls to a parser engine for parsing an output file in a first process model exchange format, a process model exchange format editor, a table wizard, a process rules compiler, a syntax parser, and/or any other methods or objects for building a rule-based translation between an entity using a first process model process model exchange format and an entity using a second process model process model exchange format.

Mapper 505 receives the output file in process model exchange format A from application 504. Mapper 505 restricts process model exchange format A to exclude classes and relationships that are proprietary in nature. In other words, mapper 505 limits the number of key words in the first process model exchange format by eliminating objects, classes, and/or relationships that are not compatible with process model exchange format B 506 to create an intermediate schema. The intermediate schema is a master process model exchange format schema that is compatible with process model exchange format B 506.

Process model exchange format B 506 is a process model exchange format associated with a destination process authoring system. A destination system is an entity that is an intended recipient of the output file. Process model exchange format B 506 is a process model exchange format that is different than process model exchange format A. Process model exchange format B 506 is a process model exchange format, such as process model exchange format B 410 in FIG. 4.

In this example, process model exchange format B 506 is a customized version of business process execution language, which may be referred to as B2PEL in these examples. However, process model exchange format B 506 is not limited to being a customized version of business process execution language. In accordance with the illustrative embodiments, process model exchange format B 506 may be any process model exchange form at that is not identical to process model exchange format A.

Next, mapper 505 extends the master data exchange schema to add unique information requirements of process model exchange format B 506. In other words, process model exchange format B 506 requires certain objects, classes, and relationships for data exchange. These objects, classes, and relationships are identified by key words. These required key words are added to the intermediate schema.

In one embodiment, mapper 505 tags key words to be excluded from the intermediate schema. Mapper 505 may also tag key words to be added to the intermediate schema. In this example, any tagged key words may be stored by mapper 505 in relational database 508. In other words, mapper 505 populates relational database 508 with common objects that are tagged to indicate the objects are supportive of process model exchange format B 506 or unsupportive of process model exchange format B 506.

Relational database 508 acts as a repository for storing objects that are common across different process model exchange formats utilized by multiple applications, entities, and/or authoring tools, such as roles, business items, locations, organizations, or any other common objects. Relational database 508 is any type of known or available relational database. Relational database 508 may be a relational database, such as process model database 114 in FIG. 1, process model database 314 in FIG. 3, or relational database 422 in FIG. 4.

An entity can interact or exchange data with relational database 508 via interface 510. Interface 510 is an interface for enabling other entities to interact with relational database 508. Interface 510 may be a component within relational database 508 or a component associated with relational database 508. Interface 510 exports tagged objects that are common to process model exchange format B 506 to mapper 505.

Mapper 505 modifies the output file to conform to the information requirements of process model exchange format B 506 using the tagged common objects received from interface 510 on relational database 508. Mapper 505 creates an application schema of application supported constructs in the output file in process model exchange format A.

Thus, in this example, the process begins when application 502 exports the output file compliant with the process model exchange format A to application 504. Application 504 authors process definitions and exports the process definitions to the output file compliant with the process model exchange format A.

Mapper 505 parses the output file to identify key words associated with the output file. Mapper 505 reads the output file line by line during the parsing process. In one embodiment, mapper 505 parses the output file by calling a parser engine which then performs the parsing operation.

Mapper 505 produces a parse report that includes the results of parsing the output file. The parse report is an intermediate file. In other words, the initial output file is parsed to form the parse report. The parse report is then converted into the tool-neutral intermediate data format based on the contents of the parse report and the requirements of process model exchange format B 506.

Application 504 reads the parse report and addresses the findings of the parse report. Mapper 505 uses an authoring tool that is compliant with process model exchange format B 506 to parse the process definition file and resolve any remaining findings. Mapper 505 submits the process definition file to relational database 508. Mapper 505 then converts the output file in process model exchange format A into a process model exchange format B 506 process definition file.

Application viewer 512 is any type of known or available software for displaying graphical representations of process models, such as application viewer 420 in FIG. 4. Application viewer 512 queries interface 510 for the process definition file in process model exchange format B 506. Application viewer 512 then receives the process definition file in process model exchange format B 506 from mapper 505.

Application viewer 512 may provide a graphical representation of the properties of the output file. Application viewer 512 enables a drill down to view the properties. The properties of the output file include a representation of what is displayed on the screen, such as activities, connectors texts, a magnification level, pan, scroll, and other viewing options associated with the file. Application viewer 512 displays a graphical representation of these properties for a user.

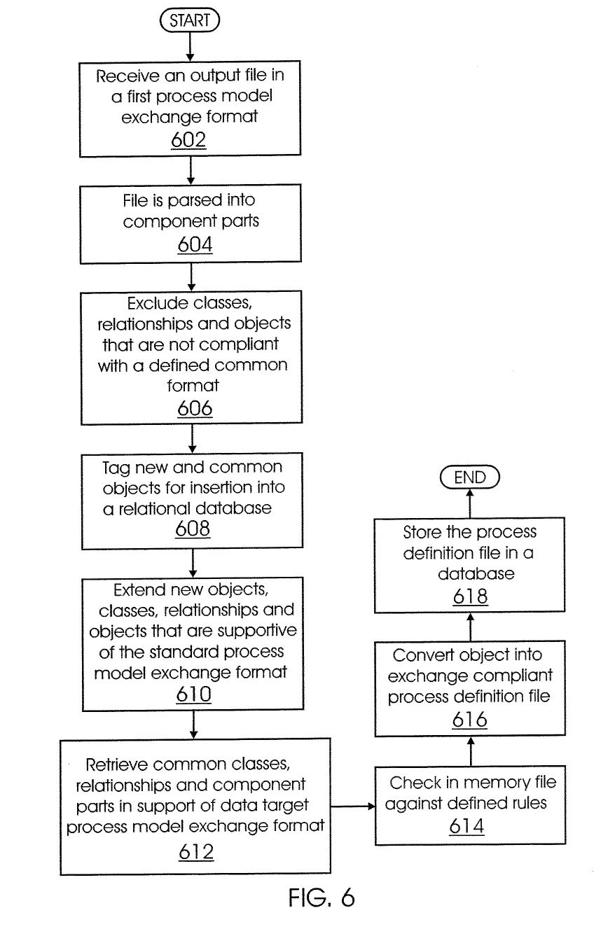

FIG. 6 is a flowchart illustrating a process for converting an export file in a first process model exchange format to a tool-neutral modeling format by a mapping component in accordance with an advantageous embodiment. The process in FIG. 6 is implemented by a software component for converting an export file in a first process model exchange format to a tool-neutral modeling format. In this examples the process may be implemented by a mapper, such as mapper 418 in FIG. 4 or mapper 505 in FIG. 5.

The process begins by receiving an output file in a first process model exchange format (operation 602). In other words, the mapper receives the output file in a neutral process model exchange format. Next, the process parses the first process model exchange format output file into component parts (operation 604). The mapper parses the output file into its component parts by following defined business rules. The mapper parses the file into individual classes, objects, relationships, and component parts and loads the results into memory.

Using the objects or tokens loaded into memory, the process excludes classes, relationships, and objects that are not compliant with a defined common format (operation 606). In this example, the common format is defined by rules entered into the mapper by an entity, such as a user or application.

The process tags new objects and common objects for insertion into a relational database, such as database process model database 114 in FIG. 1, relational database 422 in FIG. 4, or relational database 508 in FIG. 5 (operation 608). In this example, the mapper checks the objects in the objects canonical form against all combinations of the object identification in the relational database. Canonical form refers to the standard state or simplest standard form of something. New objects are tagged to be loaded into the database. Existing objects are tagged as common to two or more process model exchange formats and updated in the database as required.

Next, the process extends new object classes, relationships, and objects that are supportive of the standard process model exchange format (operation 610). In this example, the mapper extends the common objects format by adding classes, relationships, and objects that are supportive of the standard process model exchange format based on defined rules.

The process retrieves common classes, relationships, and component parts in support of the data target process model exchange format (operation 612). In other words, the mapper uses the extended common objects to construct an output file that is compliant with the requirements of the standard process model exchange format of the destination entity. The destination entity is a target entity or intended recipient of the output file.

The process checks the output file against defined business rules to make the objects in the output file conform to the business rules (operation 614). In one embodiment, the process uses a parse report to save the results of parsing the output file. The process then converts the object into an exchange compliant process definition file (operation 616). An exchange compliant process definition file is an output file that is in compliance with the process definitions of the process model exchange format associated with the destination entity.

Finally, the process stores the process definition file that is compliant with the destination process model exchange format in a data storage, such as a relational database (operation 618) with the process terminating thereafter. In this example, the data storage is a relational database, such as process model database 114 in FIG. 1, relational database 422 in FIG. 4, or relational database 508 in FIG. 5.

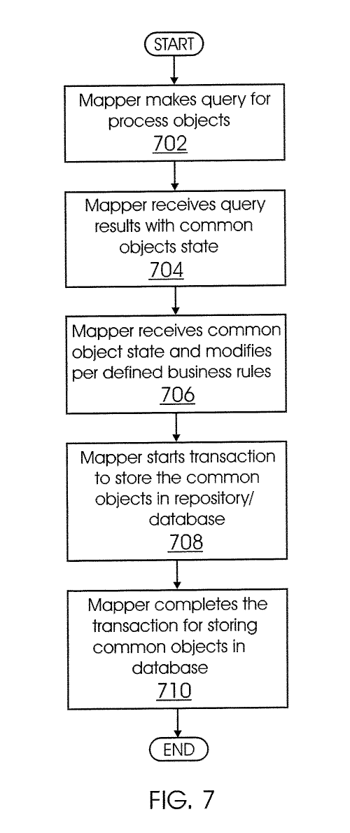

FIG. 7 is a flowchart illustrating a process for processing an export file associated with a first process model exchange format for exchange with an entity utilizing a second process model exchange format using a relational database in accordance with an advantageous embodiment. The process in FIG. 7 is implemented by a software component for converting an export file in a first process model exchange format to a tool-neutral modeling format. In this example, the process may be implemented by a mapper, such as mapper 418 in FIG. 4 or mapper 505 in FIG. 5. FIG. 7 is a more detailed process flow for extending new objects that are supportive of a second standard process model exchange format shown in operation 610 in FIG. 6.

The process begins by sending a query to a relational database to determine a state of objects loaded within a mapper entity (operation 702). The process receives query results that include common objects (operation 704). The process receives information regarding a state of the common objects and modifies the common objects to conform to common object definitions specified in defined business rules (operation 706).

Next, the process initiates a transaction to store the common objects in a repository or database (operation 708). The repository or database may be a relational database such as process model database 114 in FIG. 1, process model database 314 in FIG. 3 relational database 422 in FIG. 4, or relational database 508 in FIG. 5. In this example, the process initiates the transaction by sending the common objects to the repository or database for storage. Finally, the process completes the transaction for storing the common objects in the database (operation 710) with the process terminating thereafter.

The objects stored in the database are available for extraction by a mapper for use in generating an output file in a format compliant with a second process model exchange format. The second process model exchange format may be a process model exchange format associated with a destination entity.

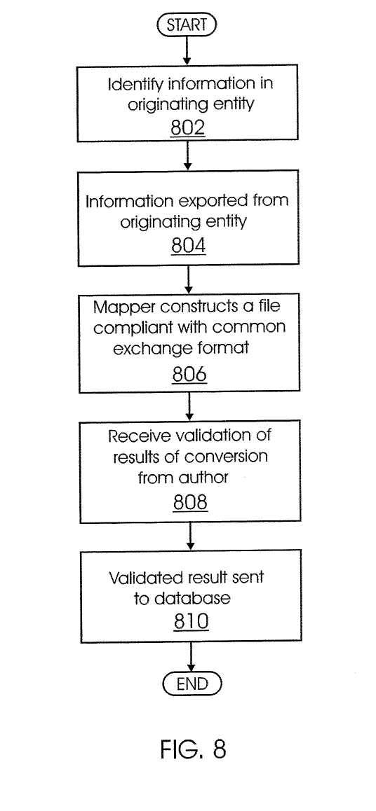

FIG. 8 is a flowchart illustrating a process for an application to export a file in a first process model exchange format to a destination associated with a second process model exchange format in accordance with an advantageous embodiment. The process in FIG. 8 may be implemented by a hardware or software entity, such as entity 404 in FIG. 4. In this example, operations 802-804 are implemented by a software application, such as application 502 in FIG. 5. Operations 806-810 are implemented by a mapper, such as mapper 418 in FIG. 4 or mapper 505 in FIG. 5.

The process begins by identifying information requirements of a first process model exchange format associated with the application for exchanging data between the application and another entity (operation 802). The process exports information from the originating entity (operation 804). In this example, the information is exported in a text-based format available in the originating system.

Next, a mapper constructs a file compliant with a common exchange format (operation 806). The mapper receives validation of the conversion results from the author (operation 808). The author is the author of the original output file. In this example, the originating author reviews the results of the mapper conversion to the common exchange format to validate the results. Finally, the mapper sends the validated results to a relational database for storage and retrieval by a requesting entity (operation 810) with the process terminating thereafter.

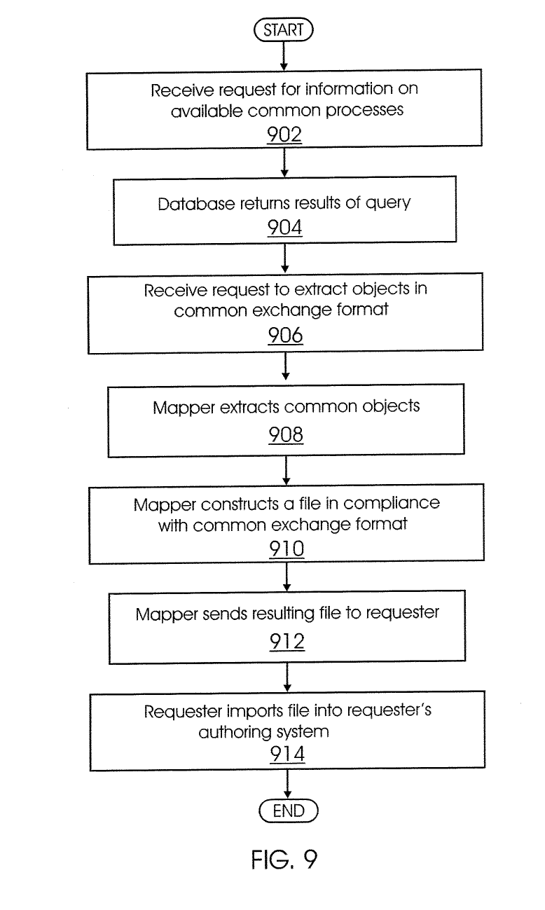

FIG. 9 is a flowchart illustrating a process for constructing a file compliant with a common exchange format in accordance with an advantageous embodiment. The process in FIG. 9 may be implemented by a software component for converting an export file in a first process model exchange format to a tool-neutral modeling format, such as mapper 418 in FIG. 4 or mapper 505 in FIG. 5. Operation 914 is performed by an entity, such as entity 302 in FIG. 3 or entity 408 in FIG. 4.

The process begins by receiving a request from an end user for information on available common processes (operation 902). In this example, the mapper sends the query to a database, such as process model database 114 in FIG. 1, process model database 314 in FIG. 3, relational database 422 in FIG. 4, or relational database 508 in FIG. 5. The process receives results of the query from the database (operation 904).

Next, the process receives a request to extract objects in the common exchange format (operation 906). In this example, the mapper receives the request from an entity, such as an end-user or application, to extract common process information in a form compatible with the target authoring system.

The process extracts the common objects information (operation 908). The process constructs a file, such as an output file, in compliance with the common exchange format (operation 910). In other words, the output file is constructed in an exchange format common to a destination entity. Next, the process sends the resulting file to the requester (operation 912). Finally, the requester imports the file into the requester's authoring system (operation 914) with the process terminating thereafter. The requester is able to use the requester's authoring system to view, alter, modify, and/or utilize data associated with the imported file despite the fact that the imported file was originated by an entity using a different target authoring tool than the source authoring tool associated with the requester.

The advantageous embodiments provide a computer implemented method, apparatus, and computer program product for exchanging process model data between process authoring tools in a process management system. A set of information requirements for exchanging the process model data between process authoring tools using different process model exchange formats within the process management system is identified. A definition of a common process model exchange format is extended to include a set of common objects using the set of information requirements to form a common process model exchange format. The set of common objects are supported between a source process authoring tool and a target process authoring tool in the process authoring tools. An output file is generated using the common process model exchange format. The common process model exchange format is compatible with a process model exchange format used by the target process authoring tool.

The illustrative embodiments provide a common method for exchanging data and protecting data during data exchange that is independent of the process or authoring toolset used. The illustrative embodiments extend or restrict standard process model exchange formats, such as business process execution language, to protect and/or enhance the format to protect data and provide a common process model exchange format for exchanging data between entities using different process model exchange formats. In this manner, the illustrative embodiments provide a common process for data exchange and protection by generating a master process model exchange format or repository that is independent of the process modeling software that generated the data being exchanged or protected.

The flowcharts and block diagrams in the different depicted embodiments illustrate the architecture, functionality, and operation of some possible implementations of apparatus, methods and computer program products. In this regard, each step in the flowchart or block diagrams may represent a module, segment, or portion of code, which comprises one or more executable instructions for implementing the specified function or functions. In some alternative implementations, the function or functions noted in the step or block may occur out of the order noted in the figures. For example, in some cases, two steps shown in succession may be executed substantially concurrently, or the steps may sometimes be executed in the reverse order, depending upon the functionality involved.

The description of the present embodiments has been presented for purposes of illustration and description, and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the embodiments for various embodiments with various modifications as are suited to the particular use contemplated.

What is claimed is:

1. A computer implemented method for creating an aerospace apparatus, the computer implemented method comprising:
identifying a set of information requirements for exchanging process model data between process authoring tools using different process model exchange formats within a process management system, wherein the process authoring tools are tools for creating the process for defining aerospace apparatus;
extending a definition of a common process model exchange format to include a set of common objects using the set of information requirements to form the common process model exchange format, wherein the set of common objects are supported between a source process authoring tool and a target process authoring tool in the process authoring tools; and
generating an output file using the common process model exchange format, wherein the common process model exchange format is compatible with a process model exchange format used by the target process authoring tool.

2. The computer implemented method of claim 1 wherein the process authoring tools for creating the process for defining aerospace apparatus includes design process authoring tools for designing the aerospace apparatus.

3. The computer implemented method of claim 1 wherein the process authoring tools for creating the process for defining aerospace apparatus includes design process authoring tools for testing designs for the aerospace apparatus.

4. The computer implemented method of claim 1 wherein the process authoring tools for creating the process for defining aerospace apparatus includes manufacturing process authoring tools for manufacturing the aerospace apparatus.

5. The computer implemented method of claim 1 further comprising:
restricting a set of unsupported objects from the definition of the common process model exchange format, wherein the set of unsupported objects are not supported between the source process authoring tool and the target process authoring tool in the process authoring tools.

6. The computer implemented method of claim 1 wherein generating the output file using the common process model exchange format further comprises:
modifying a source output file generated using the source process authoring tool to form the output file.

7. The computer implemented method of claim 1 further comprising:
populating a relational database with the set of common objects, wherein the set of common objects are found in process definition files associated with the source process authoring tool and the target process authoring tool.

8. The computer implemented method of claim 1 wherein a common object in the set of common objects is selected from a set consisting of an activity, a role, a business class, a location, a deliverable, and an organization.

9. A computer implemented method for exchanging process model data between process authoring tools in a process management system, the computer implemented method comprising:
identifying a set of information requirements for exchanging the process model data between the process authoring tools using different process model exchange formats within the process management system;
extending a definition of a common process model exchange format to include a set of common objects using the set of information requirements to form the common process model exchange format, wherein the set of common objects are supported between a source process authoring tool and a target process authoring tool in the process authoring tools; and
generating an output file using the common process model exchange format, wherein the common process model exchange format is compatible with a process model exchange format used by the target process authoring tool.

10. The computer implemented method of claim 9 further comprising:
restricting a set of unsupported objects from the definition of the common process model exchange format, wherein the set of unsupported objects are not supported between the source process authoring tool and the target process authoring tool in the process authoring tools.

11. The computer implemented method of claim 9 further comprising:
establishing data exchange rules for extending a definition of a process model exchange format associated with the source process authoring tool to exclude the set of information requirements that are supported by the process model exchange format associated with the target process authoring tool to form the common process model exchange format.

12. The computer implemented method of claim 11 wherein the data exchange rules are used for restricting the definition of the common process model exchange format to exclude the set of information requirements that are not supported by the process model exchange format associated with the target process authoring tool to form the common process model exchange format.

13. The computer implemented method of claim 9 wherein generating the output file using the common process model exchange format further comprises:
modifying a source output file generated using the source process authoring tool to form the output file.

14. The computer implemented method of claim 9 further comprising:
populating a relational database with the set of common objects, wherein the set of common objects are found in process definition files associated with the source process authoring tool.

15. The computer implemented method of claim 9 wherein a common object in the set of common objects is selected from a set consisting of an activity, a role, a business class, a location, a deliverable, and an organization.

16. A computer program product comprising:
a computer usable medium including computer usable program code for exchanging process model data between process authoring tools in a process management system, said computer program product comprising:
computer usable program code for identifying a set of information requirements for exchanging the process model data between the process authoring tools using different process model exchange formats within the process management system;
computer usable program code for extending a definition of a common process model exchange format to include a set of common objects using the set of information requirements to form the common process model exchange format, wherein the set of common objects are supported between a source process authoring tool and a target process authoring tool in the process authoring tools; and
computer usable program code for generating an output file using the common process model exchange format, wherein the common process model exchange format is compatible with a process model exchange format used by the target process authoring tool.

17. The computer program product of claim 16 further comprising:
computer usable program code for populating a relational database with the set of common objects, wherein the set of common objects are found in process definition files associated with the source process authoring tool.

18. The computer program product of claim 16 wherein the computer usable program code for generating the output file using the common process model exchange format further comprises:
computer usable program code for modifying a source output file generated using the source process authoring tool to form the output file.

19. The computer program product of claim 16 further comprising:
computer usable program code for restricting a set of unsupported objects from the definition of the common process model exchange format, wherein the set of unsupported objects are not supported between the source process authoring tool and the target process authoring tool in the process authoring tools.

20. A process modeling system, the process modeling system comprising:
a translation application, wherein the translation application identifies a set of information requirements for exchanging process model data between process authoring tools using different process model exchange formats within a process management system;
a process model database, wherein the process model database stores a set of common objects that are supported between a source process authoring tool and a target process authoring tool in the process authoring tools; and
a mapper, wherein the mapper extends a definition of a common process model exchange format to include the set of common objects using the set of information requirements to form the common process model exchange format and generates an output file using the common process model exchange format, wherein the common process model exchange format is compatible with a process model exchange format used by the target process authoring tool.
